(19) United States
(12) Patent Application Publication
(10) Pub. No.: US 2023/0001802 A1
(43) Pub. Date: Jan. 5, 2023

(54) ENERGY-STORING MOBILE DWELLING

(71) Applicant: Colorado Teardrop Trailers, LLC, Boulder, CO (US)

(72) Inventors: Dean Wiltshire, Boulder, CO (US); Benjamin Todd Shoenberger, Westminster, CO (US); William Mark Greig, Longmont, CO (US)

(73) Assignee: Colorado Teardrop Trailers, LLC, Boulder, CO (US)

(21) Appl. No.: 17/366,953

(22) Filed: Jul. 2, 2021

(51) Int. Cl. B60L 50/60; B60P 3/32; B60L 53/53; B60L 53/62; B60D 1/64; B60J 5/04; B60Q 3/30

(52) U.S. Cl. CPC B60L 50/66; B60P 3/32; B60L 53/53; B60L 53/62; B60D 1/64; B60J 5/047; B60Q 3/30

(57) ABSTRACT

A mobile dwelling includes a chassis supported by one or more axles, a shelter frame mounted to the chassis, a plurality of panels supported on the shelter frame enclose a living space. Positioned within the chassis, a plurality of battery modules are operatively isolated from the one or more axles and are adapted to selectively output power for charging a battery pack of an electric tow vehicle. A method for charging an electric vehicle includes providing a mobile dwelling, towing the mobile dwelling with an electric vehicle from a first location to a second location, coupling the battery modules with the electric vehicle and charging the electric vehicle.

### TECHNICAL FIELD

The present disclosure pertains to dwellings which may be readily transported.

### BACKGROUND

Rain, sleet, hail, wind and lightning can make a camping trip in a tent unpleasant. Rather than camp in a tent, some campers prefer a space enclosed by hard-sided walls. Potential solutions include large recreational vehicles (RVs) and camper trailers which are towed by a passenger vehicle. Camper trailers are smaller and more versatile than RVs and are easy to maneuver in the woods—and through traffic on the way to the woods.

Vehicles used to tow a camper trailer have historically been combustion-powered but with the availability of electric vehicles, a lower emission alternative is possible. Like combustion-powered vehicles, electric vehicles require energy replenishment as energy is used to propel the vehicle. As such, the range of an electric vehicle is determined by the capacity of the onboard energy storage.

### SUMMARY

The disclosure describes a mobile dwelling. The mobile dwelling includes a chassis supported by one or more axles each having a single degree of rotational freedom, a shelter frame mounted to the chassis, a plurality of panels supported on the shelter frame enclose a living space. Removably positioned within the chassis, a plurality of battery modules are operatively isolated from the one or more axles and are adapted to selectively output power for charging a battery pack of an electric tow vehicle.

The disclosure also describes a method for charging an electric vehicle. The method includes providing a mobile dwelling. The mobile dwelling has a chassis supported by one or more axles each having a single degree of freedom and a shelter frame mounted to the chassis. A plurality of panels supported on the shelter frame enclose a living space. A plurality of battery modules positioned within the chassis are operatively isolated from the one or more axles. The mobile dwelling is towed with an electric vehicle from a first location to a second location. The electric vehicle is operatively coupled with the battery modules and charged with the battery modules.

### BRIEF DESCRIPTION OF THE FIGURES

The summary above, as well as the following detailed description of illustrative embodiments, is better understood when read in conjunction with the appended drawings. For the purpose of illustrating the present disclosure, example constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 illustrates a left front perspective view of an example energy-storing mobile dwelling.

FIG. 2 illustrates a right rear perspective view of the example energy-storing mobile dwelling of FIG. 1.

FIG. 3 illustrates a left rear perspective view of the example energy-storing mobile dwelling of FIGS. 1 & 2.

FIG. 4 illustrates a top perspective view of a chassis suitable for use in association with the energy-storing mobile dwelling of FIGS. 1-3.

FIG. 5 illustrates a schematic of an example energy storing system suitable for use in association with disclosed energy-storing mobile dwellings.

FIG. 6 illustrates an example vehicle with an example energy-storing mobile dwelling in tow.

FIG. 7 illustrates an example electric vehicle being charged from an example energy-storing mobile dwelling.

### DETAILED DESCRIPTION

The following detailed description illustrates embodiments of the present disclosure and manners by which they can be implemented. Although the preferred mode of carrying out the present disclosure has been disclosed, those skilled in the art would recognize that other embodiments for carrying out or practicing the present disclosure are also possible.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

Disclosed mobile dwellings are aerodynamic and light weight to reduce power drain on the towing electric vehicle yet are sufficiently insulated for four-season camping in temperate climates and, with a hard shell, protect against bears and other intruders. The arrangement of disclosed mobile dwellings allows a family of four to comfortably camp—cooking, eating and sleeping in the wilderness.

With their torque and efficiency, EV's are effective for hauling and towing. However, towing a trailer with an EV will reduce its mileage range. There are no camper trailers able to charge electric vehicles (EVs). Storing sufficient energy in a camper trailer to charge an EV substantially eliminates or at least partially addresses problems in the prior art enabling EV operators to extend their range during towing trips remote from roadside charging stations. For example, the EV range may be extended such that it meets or exceeds its range when not towing.

Additional aspects, advantages, features and objects of the present disclosure will be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

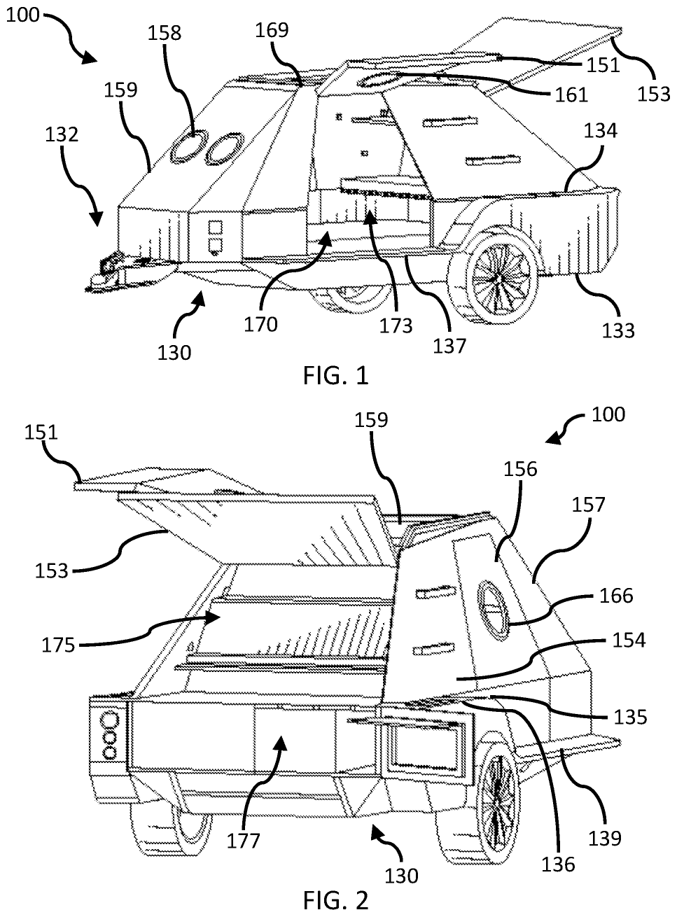

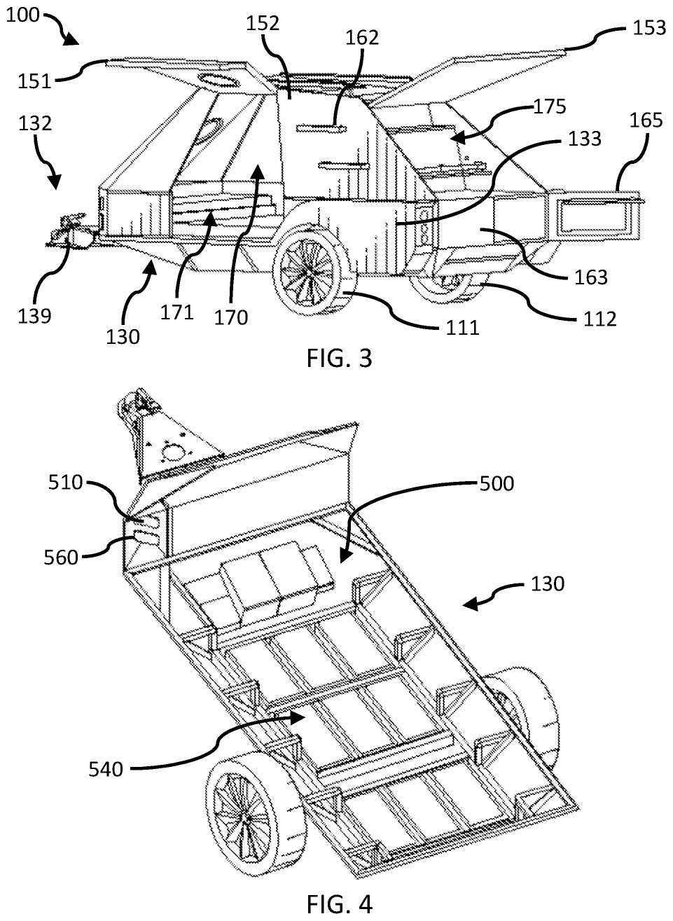

FIGS. 1-3 illustrate an example energy-storing mobile dwelling 100. Mobile dwelling 100 includes a chassis 130 supported by one or more axles configured for rotating in response to the mobile dwelling being moved by an external force. For example, the axles and/or any wheels coupled therewith may be configured for passive rotation without being powered directly by a source onboard the chassis.

The one or more axles may each have a single degree of rotational freedom. For example, with wheels 111 and 112 fixedly mounted thereto, the axles may be arranged to rotate only about their longitudinal axes and otherwise resist rotation about other axes such that they are not configured to be steered. In another example, the one or more axles may be fixed and have wheels 111 and 112 rotatably mounted thereto in which case, the axles have zero degrees of rotational freedom. In an alternative or addition, the one or more axles may be one or more spindles.

A tongue 131 is provided to or may be a part of chassis 130. Mounted to tongue 131 is a coupler 132 configured for selective connection with a hitch of a tow vehicle thereby enabling mobile dwelling 100 to be towed or hauled between locations by the tow vehicle. In an example, coupler 132 accommodates 2″ hitches.

A shelter frame or body frame (not visible) is mounted to chassis 130. A plurality of panels 151, 152, 154, 156, 157, 159 (collectively, panels 150) supported on the body frame enclose a living space 170. The body frame and/or panels 150 may be formed from any of a variety of strong, lightweight materials including but not limited to aluminum. One of panels 150 may provide a roof 159 over living space 170 and includes a glazing pane 169 enabling inhabitants to view the sky. Exterior surfaces and/or edges of mobile dwelling 100 contribute to an aerodynamic design with low drag force for mitigating range reduction of a towing vehicle. For example, edges of mobile dwelling 100 may be rounded and the overall drag coefficient may between about 0.10 and 0.20.

Mobile dwelling 100 may further include two or more gullwing doors 151 and 156 configured for selectively opening living space 170 to the environment. Gullwing doors 151 and 156 may further include one or more windows 161 and 166 enabling inhabitants of mobile dwelling 100 to view surroundings. Windows 161 and 166 which may take a circular or port-like shape may additionally be glazed. Gullwing doors 151 and 156 also facilitate support of an awning to protect users of the mobile dwelling from the elements while outside but nearby.

Mobile dwelling 100 may further include a folding sleeper couch 171 provided to a front portion of living space 170 and a retractable shelf 173 provided to a rear portion of the living space to enable transitioning between a lounge and a sleeping room for up to four persons.

Mobile dwelling 100 may further include fenders 133 and 135 partially encircling wheels mounted on the one or more axles. Fenders 133 and 135 may further include one or more storage compartments 134 and 136. In an example, fender storage compartments 134 and 136 are selectively closeable with a hinged or sliding door and are suitable for storing or otherwise containing items such as shoes, propane, a heater, hot water, a shower, a cabin heater or an air conditioner. Mobile dwelling 100 may further include running boards 137 and 139 extending forward from fenders 133 and 135 under gullwing doors 151 and 156.

Mobile dwelling 100 may further include an additional gullwing door selectively enclosing an upper galley 175 and two bi-fold doors 163 and 165 configured to selectively enclose a lower galley 177 exterior to living space 170. Galley 175 and lower galley 177 are configured to contain cooking and dining gear with sufficient room for charcoal, fire wood, camp stove, ice cooler, water, spices, french press, plates, etc.

Mobile dwelling 100 may further include a plurality of ladder rungs 162 provided at an exterior of one or more of panels 152 and 154 to facilitate access to the roof of the mobile dwelling. Ladder rungs 162 may additionally/alternatively function as mounting bars for tools such as shovels and axes.

Mobile dwelling 100 may further include one or more powered sources of illumination provided to the living space and/or the mobile dwelling exterior. For example, one or more LED lights are provided to the living space and one or more LED lights are provided to one or more of the mobile dwelling exterior surfaces. Sources of illumination and other one or more other user support items such as device charging ports may be powered by a mobile dwelling electrical system wired through the mobile dwelling. In an example the electrical system may include a battery-powered generator connected by a user or provided by a manufacturer.

The mobile dwelling living space 170 may further include an anchor point for a leg of a single-leg table suitable for use when the living space takes on a lounge configuration. For example, an anchor point such as a receptacle may be provided in the floor of the living space.

Housed by chassis 130 and drivingly decoupled from the one or more axles is an energy storing system 500. Energy storing system 500 may be an electrical power system. FIG. 4 illustrates a top perspective view of a chassis suitable for use in association with energy-storing mobile dwelling 100 of FIGS. 1-3 and emphasizing energy storing system 500.

Energy storing system 500 includes a plurality of battery modules 540 adapted to selectively store energy provided through electrical inlet 510 and output power through electrical outlet 560 for charging a battery pack of an electric passenger vehicle or other electric tow vehicle. Energy storing system 500 may be independent of and/or electrically isolated from the mobile dwelling electrical system.

In an example, battery modules 540 are removably positioned within chassis 130 and are operatively isolated from the one or more axles such that rotation of the axles and or wheels is not driven by battery modules 540 or electical system 500.

A control system is configured to control the power output from battery modules 540 during a charge cycle and control energy storage during charging of battery modules 540. A human machine interface in communication with the control system is configured to present information about performance of battery modules 540 and/or control system. Further, the human machine interface is configured to enable a user to control performance of the battery modules and/or energy storing system 500.

Charging capability of battery modules 540 is equal to or greater than the effective range loss from towing the mobile dwelling. Further, battery modules 540 may have a storage capacity equal to or greater than an amount of tow vehicle energy consumption increase from towing the mobile dwelling. In other words, the capacity of battery modules 540 offsets an amount of tow vehicle energy consumption increase from towing the mobile dwelling. For example, the capacity of battery modules 540 may compensate for the mobile dwelling weight, mobile dwelling aerodynamic drag and mobile dwelling rolling resistance during towing thereof. In a further example, the capacity of the battery modules 540 may be between 35 kWh and 100 kWh.

Battery modules 540 may be electrically coupled in parallel. The battery modules 540 may each include a plurality of electrochemical cells electrically coupled together, for example, by bus bars. In an example, the electrochemical cells are 3400 mAh, 3.7V lithium-ion cells and combined yield a 22.5V, 5.3 kWh battery module.

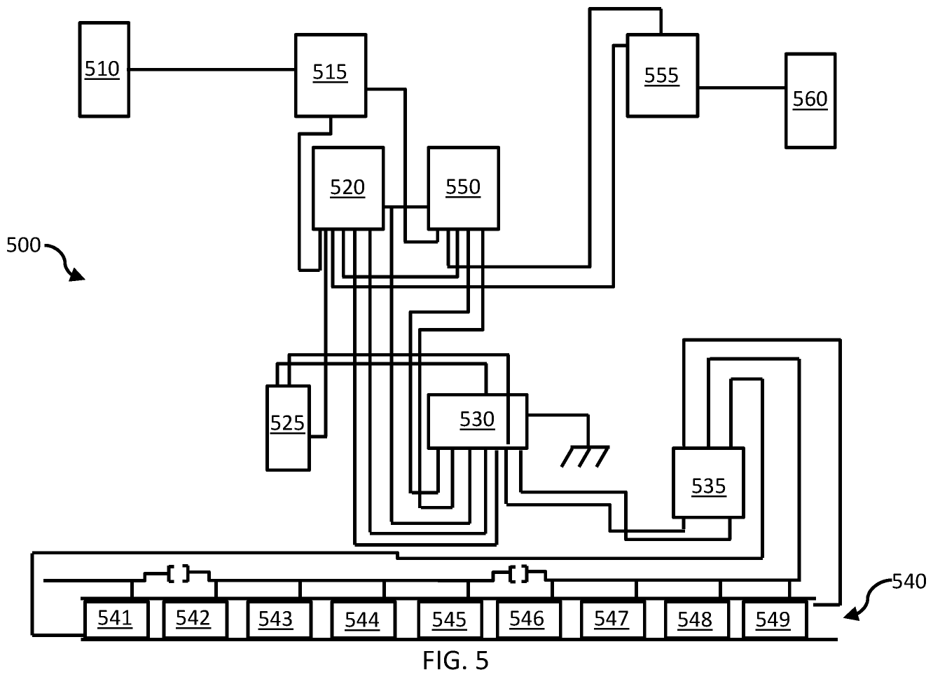

FIG. 5 illustrates a schematic of an example energy storing system 500 suitable for use in association with disclosed energy-storing mobile dwellings. Mobile dwelling 100 may further include a module controller 535 operatively coupled between battery modules 540 and each of electrical inlet 510 and electrical outlet 560. Module controller 535 may be provided with a processing chip or system on a chip programmed to calculate power into and out of batter modules 540 or a pack thereof, measure current and power flow, record peaks of current and voltage and configure parameters. In an example, module controller 535 is configured to communicate with up to 62 battery modules.

The mobile dwelling may further include first 520 and second 550 inverter/chargers operatively coupled between battery modules 540 and each of electrical inlet 510 and electrical outlet 560. Inverter/chargers 520 and 550 are configured to convert direct current delivered from battery modules 540 into alternating current to be output through power-out splitter 555 and, in turn, electrical outlet 560. In an example, first 520 and second 550 inverter/chargers are operatively coupled with a modular bus bar or distributor 530. An example inverter/charger has an input voltage range of 9-33V, an output of 120 VAC and an efficiency of up to 94% as an inverter and an input voltage range of 95-140 VAC; an absorption voltage of 28.8 and a storage mode voltage of 26.4.

Distributor 530 is operatively coupled between battery modules 540 and each of electrical inlet 510 and electrical outlet 560. In an example, distributor 530 is operatively coupled between module controller 535 and first and second inverter/chargers 520 and 560 and is configured to distribute power provided from battery modules 540 through module controller 535 to inverter/chargers 520 and 550. An example distributor has a voltage range between 9 and 60 Vdc; supported system voltages of 12, 24 or 48V; has a current rating of 1000 A and has a maximum power consumption of 100 mA.

Power-in splitter 515 and power-out splitter 555 are coupled with each of first 520 and second 550 inverter/chargers.

Electrical inlet 510 is operatively coupled with battery modules 540 through power-in splitter 515 which divides power in from electrical inlet 510 for use by first 520 and second 550 inverter/chargers.

Electrical outlet 560 is operatively coupled with battery modules 540 through power-out splitter 555 which combines power from first 520 and second 550 inverter/chargers. Electrical outlet 560 is configured to charge an electric vehicle.

A ground may be operatively coupled between energy-storing system 500 and chassis 130. In an example, the ground is operatively coupled between distributor 530 and chassis 130.

Mobile dwelling 100 may further include a dongle 525 communicatively coupled with battery modules 540 and configured to output performance information of energy storing system 500 such as temperature and voltage. In an example, dongle 525 is communicatively coupled with distributor 530 and is configured to output information by short-range radio transmission to a mobile device such as a mobile phone or tablet. In an example, dongle 525 is further configured to change current input limit and switch inverter/chargers 520 and 550 between off, on and charger-only modes.

Disclosed mobile dwellings may be suitable for use in various methods for charging electric vehicles. One method includes providing a mobile dwelling having a chassis supported by one or more axles each having a single degree of freedom and a shelter frame mounted to the chassis. A plurality of panels supported on the shelter frame enclose a living space. A plurality of battery modules positioned within the chassis are operatively isolated from the one or more axles.

Energy may be stored with the battery modules, for example, by charging at a charging station such as at a residence or a commercial site. The amount of energy charged into or stored by the battery modules may be equal to or greater than an amount of tow vehicle energy consumption increase from towing the mobile dwelling, for example, due to the mobile dwelling weight and/or aerodynamic drag. In other words, the amount of energy stored by the battery modules may be the amount of energy offsetting the increase in tow vehicle energy consumption due to towing the mobile dwelling. Performance information of the storing may be output through a dongle communicatively coupled with the battery modules.

The provided mobile dwelling may be prepared for towing by a vehicle, such as an electric vehicle, by connecting a hitch of the electric vehicle to a coupler mounted on a tongue provided to the chassis.

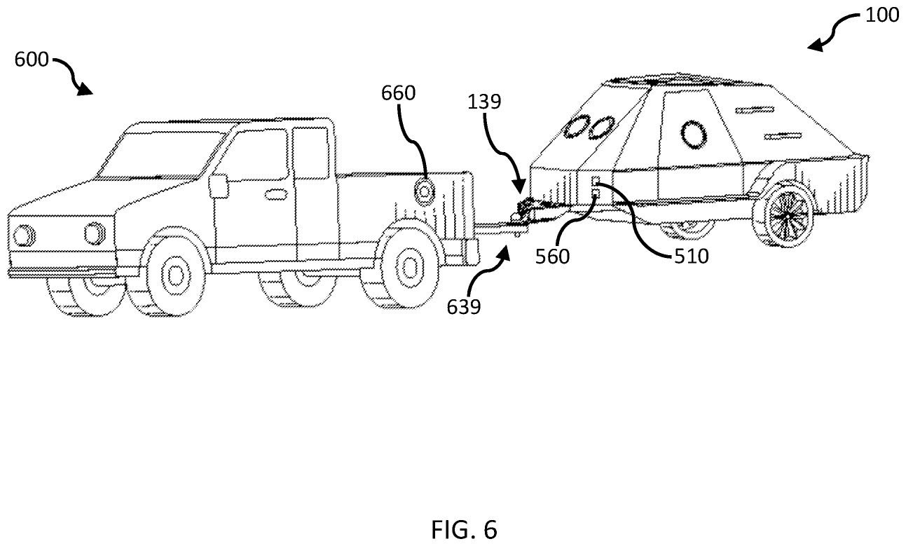

The mobile dwelling may be towed with the vehicle from a first location to a second location. FIG. 6 illustrates an example vehicle 600 with an example energy-storing mobile dwelling 100 in tow as enabled through hitch 639 and coupler 132.

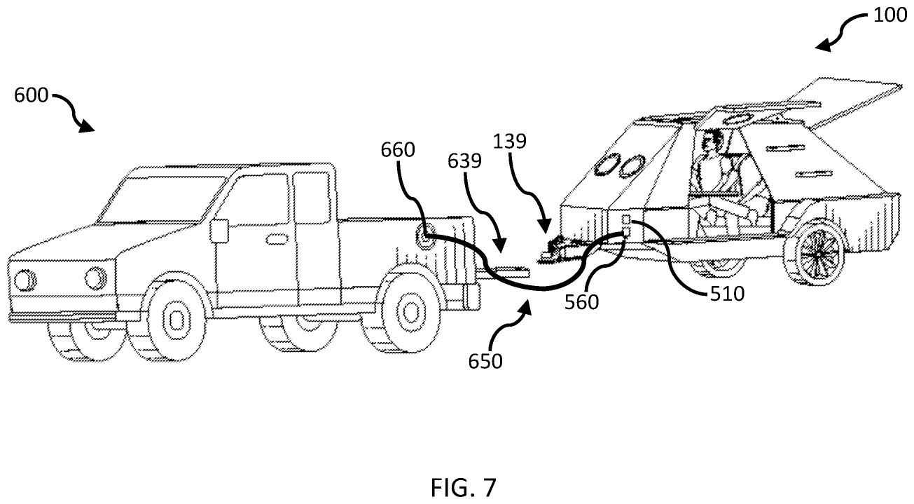

The electric vehicle is operatively coupled with the battery modules through an electrical outlet and charged thereby. Performance information of the charging may be output through a dongle communicatively coupled with the battery modules. FIG. 7 illustrates an example electric vehicle 600 being charged by an example energy-storing mobile dwelling 100 from an electrical outlet 560 of the mobile dwelling, through a charging cable 650 to an electrical inlet 660 of tow vehicle 600.

The actions described above are only illustrative and other alternatives can also be provided where one or more actions are added, one or more actions are removed, or one or more actions are provided in a different sequence without departing from the scope of the claims herein. Further, the method may be performed with tow vehicles and/or energy-storing mobile dwellings other than those disclosed.

Embodiments of the present disclosure are susceptible to being used for various purposes, including, though not limited to, enabling users to tow a mobile dwelling long distances with an electric vehicle.

Disclosed mobile dwellings may be suitable for use as a travel trailer such as, for example, a camper trailer. The mobile dwelling may take the form of a teardrop which may be referred to as a teardrop trailer.

Alternatively, disclosed mobile dwellings could be used as commercial marketing vehicles to display or promote product while being towed by an electric vehicle. Instead of a family camping, it could be used to haul, display and promote product to farmer's markets, tradeshows, festivals, etc.

Modifications to embodiments of the present disclosure described in the foregoing are possible without departing from the scope of the present disclosure as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

What is claimed is:

1. A mobile dwelling, comprising:
a chassis supported by one or more axles each having a single degree of rotational freedom;
a shelter frame mounted to the chassis;
enclosing a living space, a plurality of panels supported on the shelter frame; and
positioned within the chassis, a plurality of battery modules are operatively isolated from the one or more axles and are adapted to selectively output power for charging a battery pack of an electric tow vehicle

2. The mobile dwelling as set forth in claim 1, wherein the battery modules are electrically coupled in parallel.

3. The mobile dwelling as set forth in claim 1, wherein the battery modules each further comprise a plurality of electrochemical cells.

4. The mobile dwelling as set forth in claim 1, further comprising a dongle communicatively coupled with the battery modules and configured to output performance information thereof.

5. The mobile dwelling as set forth in claim 1, further comprising:
a tongue provided to the chassis;
mounted to the tongue, a coupler configured for selective connection with a hitch of the tow vehicle.

6. The mobile dwelling as set forth in claim 1, further comprising two or more gullwing doors configured for selectively opening the living space to the environment.

7. The mobile dwelling as set forth in claim 1, further comprising one or more sources of powered illumination provided to the living space.

8. The mobile dwelling as set forth in claim 1, wherein the battery modules have a storage capacity equal to or greater than an amount of tow vehicle energy consumption increase from towing the mobile dwelling.

9. The mobile dwelling as set forth in claim 1, wherein the battery modules have a storage capacity equal to or greater than an amount of tow vehicle energy consumption increase from the mobile dwelling weight during towing thereof.

10. The mobile dwelling as set forth in claim 1, wherein the battery modules have a storage capacity equal to or greater than an amount of tow vehicle energy consumption increase from the mobile dwelling drag during towing thereof.

11. A method for charging an electric vehicle, comprising:
providing a mobile dwelling having:
a chassis supported by one or more axles each having a single degree of freedom;
a shelter frame mounted to the chassis;
enclosing a living space, a plurality of panels supported on the shelter frame; and
removably positioned within the chassis, a plurality of battery modules are operatively isolated from the one or more axles;
towing the mobile dwelling with an electric vehicle from a first location to a second location;
operatively coupling the electric vehicle with the battery modules; and
charging the electric vehicle with the battery modules.

12. The method as set forth in claim 11, further comprising, to a coupler mounted on a tongue provided to the chassis, connecting a hitch of the electric vehicle.

13. The method as set forth in claim 11, further comprising, through a dongle communicatively coupled with the battery modules, outputting performance information of the charging.

14. The method as set forth in claim 11, further comprising, storing energy with the battery modules.

15. The method as set forth in claim 11, further comprising, with the battery modules, storing an amount of energy equal to or greater than an amount of tow vehicle energy consumption increase from towing the mobile dwelling.

16. The method as set forth in claim 11, further comprising, with the battery modules, storing an amount of energy equal to or greater than an amount of tow vehicle energy consumption increase from the mobile dwelling weight during towing thereof.

17. The method as set forth in claim 11, further comprising, with the battery modules, storing an amount of energy equal to or greater than an amount of tow vehicle energy consumption increase from the mobile dwelling drag during towing thereof.

18. The method as set forth in claim 11, wherein charging the electric vehicle with the battery modules further comprises, charging an amount of energy equal to or greater than an amount of tow vehicle energy consumption increase from towing the mobile dwelling.

19. The method as set forth in claim 11, wherein charging the electric vehicle with the battery modules further comprises, charging an amount of energy equal to or greater than an amount of tow vehicle energy consumption increase from the mobile dwelling weight during towing thereof.

20. The method as set forth in claim 11, wherein charging the electric vehicle with the battery modules further comprises, charging an amount of energy equal to or greater than an amount of tow vehicle energy consumption increase from the mobile dwelling drag during towing thereof.
